(19) United States
(12) Patent Application Publication
(10) Pub. No.: US 2010/0239790 A1
(43) Pub. Date: Sep. 23, 2010

(54) SYSTEM AND METHOD FOR AN IMPROVED ARTIFICIAL TURF

(76) Inventors: Phillip M. Stricklen, Dalton, GA (US); Michael M. Schneider, Havre de Grace, MD (US)

Correspondence Address: Law Office of Bill Naifeh, 6600 LBJ Freeway, Suite 175, Dallas, TX, 75240, US

(21) Appl. No.: 12/407,748

(22) Filed: Mar. 19, 2009

(51) Int. Cl. A41G 1/00; B05C 1/00

(52) U.S. Cl. 428/17; 427/136

(57) ABSTRACT

Embodiments of a synthetic turf system are disclosed generally comprising: a water barrier or impermeable layer adapted to be placed on top of a soil surface; a water permeable foam pad for the collection and drainage of water; a water permeable substrate material; a plurality of tufts coupled to the substrate material formed to resemble grass; a layer of non-resilient particles placed on the substrate material, and a layer of resilient particles placed on top of the layer of non-resilient particles.

### TECHNICAL FIELD

This disclosure relates to artificial turf surfaces in general and, more specifically, to a system and method for an improved artificial turf.

### BACKGROUND INFORMATION

Artificial turf surfaces have progressed from rudimentary materials and fabrics that were simply applied to a playing surface to systems that actually replicate the look and feel of real grass turf. Modern turf surfaces can replicate real grass down to single blades of grass. Infill material may be utilized between the artificial grass fibers to replicate the soil or sand found with real grass fields.

However, as modern surfaces become more complex, so have their design considerations. For instance, existing turf systems represent a compromise between performance and safety.

When a player falls, the impact is absorbed either by the playing surface or the player's body. The “harder” the surface, the greater the amount of the impact absorbed by the player's body. The greater the amount of impact absorbed by the player's body, the greater the likelihood that the fall will result in injury. This is especially true with respect to traumatic injuries to the brain—which can occur when the player's head hits the playing surface.

Impact testing (commonly referred to as g-max testing) is commonly used to measure the shock-absorbing properties of sports surfaces—including synthetic (artificial) turf and natural turf athletic fields. The g-max values are expressed in a ratio: the ratio of the maximum acceleration (deceleration) experienced during an impact, to the normal rate of acceleration due to gravity. The higher the g-max value, the lower the shock-absorbing properties of the surface. Thus from a safety perspective, lower g-max values are preferable. In fact, if a surface has a g-max value over 200, the field is considered unsafe.

On the other hand, a g-max value that is too low may reduce the playability of the field. Most designers believe that fields that are too “hard” are dangerous, while fields that are too “soft” contribute to excessive fatigue and poor player performance. Thus, many designers will specify a range for a field which is often a compromise between an acceptable g-max values and performance criteria. The typical range sets an upper limit that addresses safety, and a lower limit that focuses on playability.

The Committee for European Standardization (“CEN”) has produced several tests designed to indicate performance criteria for a synthetic turf field. These test include: EN 12234 Surfaces for Sports Areas—Determination of Ball Roll, EN 14808 Surfaces for Sports Areas—Determination of Shock Absorption, EN 14809 Surfaces for Sports Areas—Determination of Vertical Deformation, EN 15301 Surfaces for Sports Areas—Part 1—Determination of Rotational Resistance. Traditional systems must balance between performance criteria and acceptable g-max values.

Another issue with many synthetic turf surfaces is the removal of rain water. If water becomes trapped under the synthetic surface, structural damage to the subsurface may occur which will greatly reduce the useful life of a sport field. A crushed stone base has been traditionally used to provide a level playing field and to drain water away from the playing surface. If the stone base is not compacted properly, it will not drain which creates problems for the synthetic surface.

What is needed is a method and system for addressing the above and related issues.

### SUMMARY

In response to these and other problems, in one embodiment, there is a synthetic turf system generally comprising: a water barrier or impermeable layer adapted to be placed on top of a soil surface; a water permeable foam pad for the collection and drainage of water; a water permeable substrate material; a plurality of tufts coupled to the substrate material formed to resemble grass; a layer of non-resilient particles placed on the substrate material, and a layer of resilient particles placed on top of the layer of non-resilient particles. Such a system produces a superior balance of safety and performance over traditional systems.

These and other features, and advantages, will be more clearly understood from the following detailed description taken in conjunction with the accompanying drawings. It is important to note the drawings are not intended to represent the only aspect of the invention.

### BRIEF DESCRIPTION OF THE DRAWINGS

FIG. 1 is a cross-sectional schematic view of a portion of a conventional artificial turf system.

FIG. 2 is a partially exploded perspective view of a portion of a synthetic turf system in accordance with certain aspects of the present invention.

FIG. 3 is a cross-sectional schematic view of a portion of an artificial turf system in accordance with certain aspects of the present invention.

FIG. 4 is a top view of a playing field using one aspect of the present disclosure.

### DETAILED DESCRIPTION

For the purposes of promoting an understanding of the principles of the present inventions, reference will now be made to the embodiments, or examples, illustrated in the drawings and specific language will be used to describe the same. It will nevertheless be understood that no limitation of the scope of the invention is thereby intended. Any alterations and further modifications in the described embodiments, and any further applications of the principles of the inventions as described herein are contemplated as would normally occur to one skilled in the art to which the invention relates.

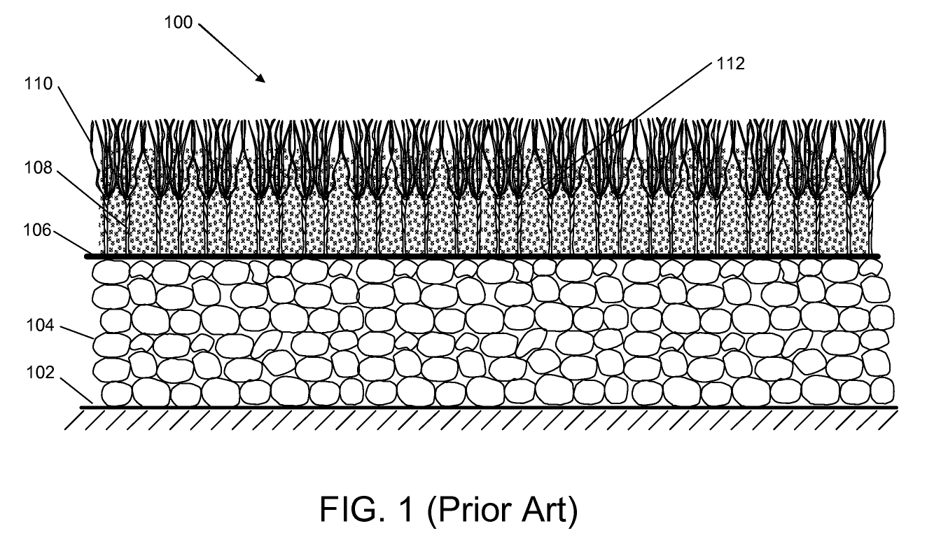

FIG. 1 is a “conceptual” cross-sectional view of a conventional synthetic turf system 100. Typically, such systems are employed on top of a compacted surface 102 of soil and fill material. Typically, such a compacted surface 102 would be compacted to about 95 percent of standard proctor. The compacted surface 102 is typically prepared by scraping a top layer of organic dirt, stabilizing a layer of sub-base material with lime and/or aggregate, then compacting the surface.

Once the surface 102 has been stabilized and compacted, natural stone or gravel is typically placed on top of the compacted surface 102 to form a drainable layer 104 that is commonly referred to as an Open Graded Based Course, or “OGBC.” Typically, the drainable layer 104 is 6 to 12″ in height. Furthermore, there may be a vertical gradation of stone sizes within the drainable layer.

Synthetic turf material may then be placed on the drainable layer 104. Typically, the synthetic turf material includes a backing or substrate 106 and turf fibers 108. The substrate 106 may be a woven material or may be layered. Turf fibers 108 may be tufted through one or more layers of the substrate 106. When the turf fibers 108 are made from slit tape, grass blades 110 are created when the upper portion of the turf fibers have untwisted and the small connecting segments between the individual fibrils have broken to allow the fibers to resemble grass blades. When the turf fibers are monofilaments, the turf fibers 108 untwist and the individual filaments spread apart to create artificial grass blades 110. The height or “lengths” of the turf fibers 108 are typically between about 2 to 2.5 inches.

Infill material 112 is typically provided between the artificial grass blades 110 to provide for a cushion from the relatively hard drainable layer 104. The infill material 112 is typically applied in such a way as to replicate to some degree the soil or sand of a natural turf playing field. Rubber particles are often used as infill material. The rubber particles may be ambient ground rubber or cryogenically processed rubber. In other embodiments, the infill material may be a mixture of sand and rubber. Typically, the thickness of the infill material is from 1.5 to 2.0″. So, the artificial grass blades 110 will rise approximately ⅝″ above the infill material 112 as a natural blade of grass would rise above the underlying soil.

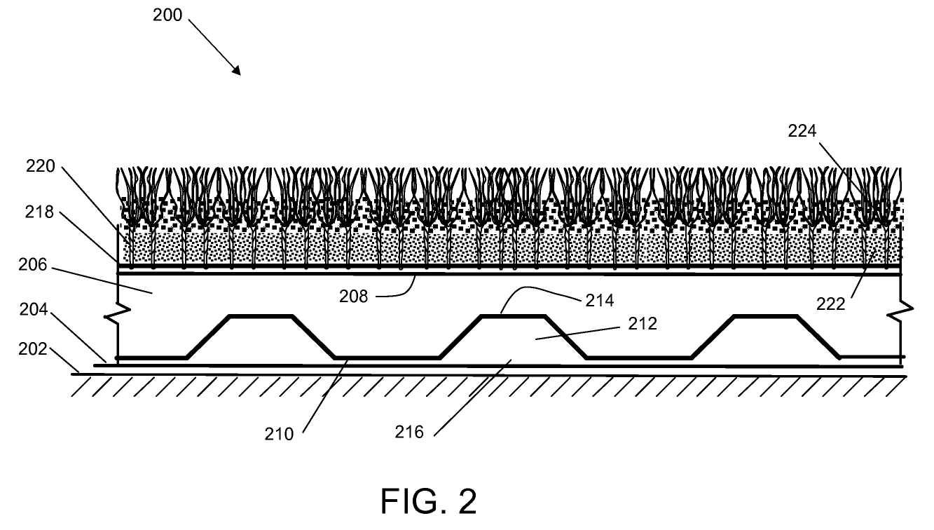

FIG. 2 is a “conceptual” cross-sectional view of a synthetic turf system 200 incorporating various aspects of the present invention. There is illustrated a compacted soil surface 202 having a sufficient degree of slope to drain water from the field. In certain embodiments, the soil surface 202 may be similar to the soil surface 102 described previously in reference to FIG. 1. A non-permeable liner 204 may be placed on top of the soil surface 202 to prevent water reacting with and causing damage to the soil sub-base below. A pad 206 may be placed over the non-permeable liner 204.

In some embodiments, the pad 206 may be formed from particulates or pieces of flexible foam of a particular gradation or size to allow for vertical and/or horizontal drainage of water. In certain embodiments, the flexible foam may be a cross-linked polyethylene foam or a cross-linked high density polyethylene (“HDPE” foam), polystyrene foam. In some embodiments, the flexible foam materials may be derived from virgin or postindustrial waste sources, or from a combination of both. The particulate materials range in size and shape to maximize porosity similar to natural aggregate materials. In certain embodiments, the flexible foam may be shredded to produce particulate pieces with irregular, granular shaped particles having a diameter of approximately ⅛″ to 1″. If any fines are produced during the shredding process, the particulate foam may be screened to remove the fines. In certain embodiments, the sizes of the foam may be gap graded to maximize permeability.

In certain embodiments, the particulate foam may then be adhered to one another in a random fashion through a partial fusing by applying heat and pressure. In other embodiments, a suitable adhesive may be used to join the particles together to form the particulate foam. The desired thickness of the pad 206 may be achieved by applying pressure to the particulates to compress the particulates into a pad having a predetermined height and porosity. Typically, the height of the pads may be in the range of 0.4″ to 2″ and the permeability of certain embodiments of the pads will be greater than 34 gallons/min/ft, as measured by ASTM D2434 M. In certain embodiments, an upper surface 208 and the lower surface 210 of the drain pad 206 may be planed to achieve a uniform thickness.

Drainage channels 212 may be formed on one side of the drain pad 206 to provide for horizontal transmission of water. In certain embodiments, the drainage channels 212 can be any number of sizes and/or shapes. In certain embodiments, the channels 212 may be generally trapezoidal in cross-sectional shape having a top base 214, which has a width ranging from ½″ to ¾″ and a bottom base opening 216, which has a width ranging from 1″ to 1¼″. In certain embodiments, the channels may have a 2.5″ center-to-center spacing.

Because certain embodiments of the pad 206 are made from a cross linked foam or a cross linked high density polyethylene (“HDPE” foam), there is a certain amount of flexibility and resiliency in the pad which allows it to have shock absorbing characteristics. As will be explained in greater detail below, the shock absorbing characteristics allows the system 200 to have the g-max characteristics similar to conventional systems while achieving superior performance characteristics. In certain embodiments, the pad 206 may be formed into rolls having dimensions of 4 feet in width, 210 feet in length, and 1″ in height.

Once the pad 206 is position over the impermeable liner 204, synthetic turf material may be placed over the pad. In certain embodiments, the synthetic turf material includes a backing or substrate 218 and turf fibers 220 which may be sewn or tufted through one or more layers of the substrate 218 to resemble artificial grass blades. In certain embodiments, the lengths of the turf fibers 220 may range between 1.25 and 1.75 inches, for instance, 1.5 inches. Thus, the turf fibers 220 are shorter than turf fibers used in traditional systems.

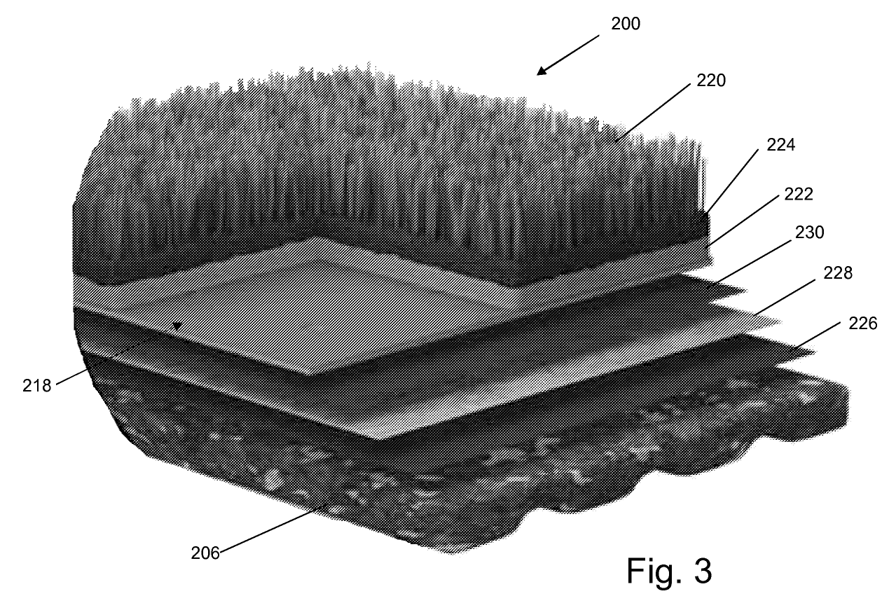

The substrate 218 is permeable to allow water to flow vertically through the substrate. In certain embodiments, the substrate 218 has a plurality of weep holes (not shown) to allow rain water or other fluids to pass through the substrate and on to the pad 206. In some embodiments, the weep holes may have a center to center spacing ranging between 3″ to 4″ and a diameter of approximately ⅜″. In other embodiments, the substrate 218 could be woven or knitted to contain void spaces (i.e., holes or perforations) within the fabric to allow water to vertically drain through the substrate. Details of one embodiment of the substrate material is described below with respect to FIG. 3. An alternative substrate system is described in commonly owned U.S. application Ser. No. 10/666,901, entitled “Artificial Turf Backing,” which is incorporated by reference herein for all purposes.

A non-resilient layer 222 of infill material may then be placed on top of the substrate 218 and between the turf fibers 220. The non-resilient layer 222 provides for a ballast to assist in keeping the synthetic turf in position and provides firmness to the surface which increases the athletic performance. In certain embodiments, the non-resilient layer 222 mainly comprises silica sand having a mesh size of 10 to 50 mesh (preferably 20 to 40 mesh) which may be placed to a depth ranging between 10 and 20 mm (preferably approximately 10 mm).

In some embodiments, a resilient layer 224 of infill material having a larger particle size (mesh size between 8 to 30, or preferably 10 and 20) may then be applied on top of the non-resilient layer 222 to a depth ranging between 10 and 20 mm (preferably approximately 10 mm). The resilient layer 224 of infill material provides for an additional shock absorption layer in addition to the pad 206 to provide for a greater level of safety than typically provided with conventional systems. The resilient layer 224 also provides for a surface that is similar to a natural grass surface. In certain embodiments, the resilient layer 224 of infill material may be recycled rubber or virgin elastomer particles. The rubber particles may be ambient ground rubber or cryogenically processed rubber. For instance, the infill may be made from styrene butadiene rubber (“SBR”) or thermoplastic elastomers (“TPE”).

Alternatively, in some embodiments, there may be a single layer of in-fill comprising coated sand particles, where the sand particles have been coated with a flexible material. In certain embodiments, the flexible coating may be an acrylic coating. In other embodiments, the flexible coating may be an elastomer.

FIG. 3 is a partially exploded isometric view of the synthetic turf system 200 showing the pad 206, the substrate 218, the non-resilient layer 222, the resilient layer 224, and the turf fibers 220. In this illustration, the embodiment of the substrate 218 has been exploded to show some of the various layers of the substrate.

The illustrated embodiment has a bottom layer 226 of the substrate 218 which serves as the primary backing to lock in the tuffs of turf fibers 220. In some embodiments, the bottom layer 226 may be made from a woven polypropylene primary backing such as Polybac® (available from Propex which is global supplier of polypropylene fabrics). In certain embodiments, a polyurethane backing may be applied to the bottom surface of the bottom layer 226 after the tufts are in place.

In certain embodiments, the bottom layer 226 may be coupled to an intermediate layer 228. The intermediate layer 228 may be a non-woven primary backing to add dimensional stability during manufacturing and installation of the substrate 218. In certain embodiments, the non-woven backing may be made from Duraback™, which is also available from Propex.

In certain embodiments, a top layer 230 of a woven polypropylene primary backing such as Polybac® is positioned on top of the intermediate layer 228. The turf fibers are tufted through all three layers.

Referring back to both FIG. 2 and FIG. 3, it can be seen that water, such as rain water which falls on top of the system 200 will drip through resilient layer 224 and non-resilient layer 222 to the top surface of the substrate 218. The permeability of the substrate 218 allows the water to pass through the substrate 218 and onto the top surface 208 of the pad 206. The top surface 208 of the pad 206 is porous which allows the water to enter voids between the foam particulates. The foam particulates themselves are also porous so that water will flow down through the pad 206 and into the channels 212. The non-permeable liner 204 keeps the water away from the soil surface 202 so the water accumulates in the channels 212. There is a slight grade of the soil surface 202 which will cause any accumulated water in the channels to drain away from the center of the playing field.

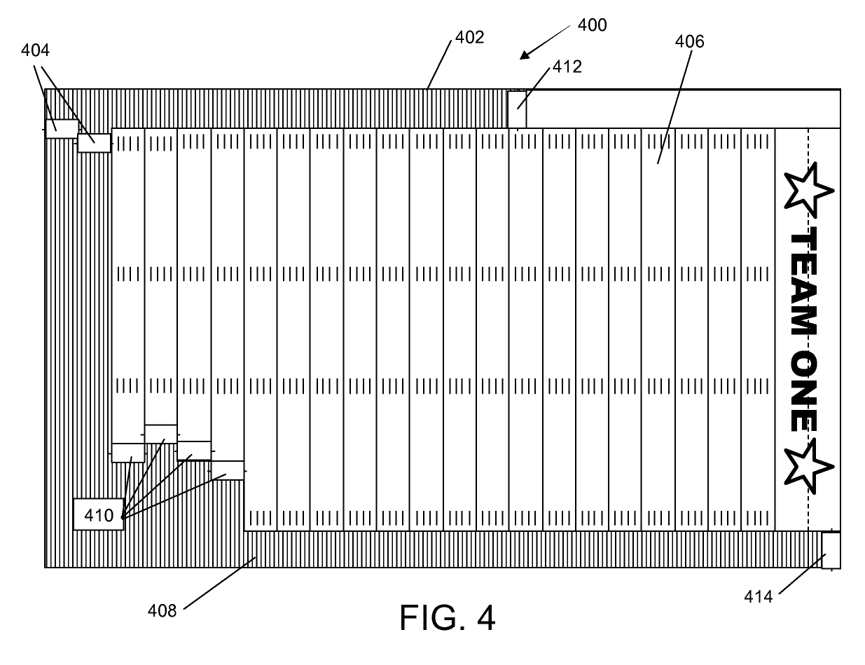

Referring now to FIG. 4, there is illustrated a turf system 400 comprising a plurality of rolls and/or panels of artificial turf being installed and on a sports field 402. As used in this disclosure, a “panel” is an unrolled rectangular section of synthetic turf material. When the section is in a rolled configuration, the section will be referred to as a “roll.” Thus, the terms “roll” and “panel” will be used interchangeably depending on whether the section of turf is in a rolled or flat configuration. In certain embodiments, the turf rolls may be wrapped around a support or pole. This may allow the turf roll to be easily transported by truck, forklift, or crane, for example.

As illustrated, the sports field 402 is an American football field. An American football field may also have additional markings (yard lines, hash marks, etc) but all of the markings will not be reproduced here for clarity. It can be seen here, that the panels are all rectilinear in shape but other embodiments may provide varying shapes for the panels. The actual number of panels utilized to provide the entire playing surface may vary based upon the needs of the user, the sport, and the size of the field.

As illustrated, some of the rolls of synthetic turf material, for instance rolls 404, have not yet been installed. In contrast, certain rolls have already been unrolled to form rectangular panels 406 which cover pads 408. As illustrated, the pads 408 have already been unrolled over the field 402. In the illustrated embodiment, the pads 408 are 4′×210′ and are placed side to side across the field 402. In certain embodiments, the rolls 404 and panels 406 of turf material have a width of 15 feet. Thus, in this exemplary embodiment, there are 3.75 pads for each roll of turf material. These dimensions assure that the seams between the rolls 404 of turf material are offset from the seams between the pads 408.

As illustrated, a plurality of panels 406 have been unrolled to form a portion of the field of play. A plurality of panels 410 are illustrated in a partially unrolled position. A roll 412 is shown being unrolled transverse to the plurality of panels 408 to form a side panel. A roll 414 is positioned on the opposite side of the field of play, but has not been unrolled. When installed, the roll 414 will form the other side panel. Similarly, rolls 404 will form an end zone once the rolls 404 are unrolled into panels.

### Experimental Results

Safety impact measurements (g-max) were taken for four systems employing various aspects of the present invention and for two different traditional systems. Additionally, playability performance measurements were taken according to CEN criteria. The playability performance measurements include: Force Reduction (%), Vertical Deformation (mm), Rotational Resistance (Nm), and Vertical Ball Rebound (m).

The g-max tests were conducted according to ASTM standard test method F355. The Vertical Ball Rebound tests were conducted according to ASTM standard test method F2117. The Force Reduction measurements were conducted according to CEN standard test method EN 14808 Surfaces for Sports Areas—Determination of Shock Absorption. The Vertical Deformation measurements were made according to CEN standard test method EN 14809 Surfaces for Sports Areas—Determination of Vertical Deformation. The Rotational Resistance measurements were made according to CEN standard test EN 15301 Surfaces for Sports Areas—Part 1—Determination of Rotational Resistance.

For the g-max measurements, a lower value means the surface absorbs more energy and is safer. The preferred range is between 80 and 120. For the Force Reduction measurements the preferred range is between 55 and 70%. For the Vertical Deformation, the preferred range is between 4 and 9 mm. For Rotational Resistance the preferred range is 25 to 50 NM. For Vertical Ball Rebound, the preferred range is 0.6 to 1.0 m.

The results of these measurements are illustrated in Table 1, below:

| | | | | | Traditional | Traditional |
|---|---|---|---|---|---|---|
| | System 1 | System 2 | System 3 | System 4 | System 1 | System 2 |
| Measurement | | | | | | |
| g-max | 94 | 88 | 98 | 91 | 95 | 98 |
| Force Reduction | 60.4 | 59.5 | 59.4 | 58.5 | 61 | 65 |
| (%) | | | | | | |
| Vertical | 6.7 | 6.6 | 6.5 | 6.3 | 7.5 | 8 |
| Deformation (mm) | | | | | | |
| Rotational | 47.5 | 42.6 | 47.9 | 48.5 | 36 | 38.5 |
| Resistance (Nm) | | | | | | |
| Vertical Ball | 0.75 | 0.77 | 0.75 | 0.76 | 0.9 | 0.84 |
| Rebound (m) | | | | | | |
| System Properties | | | | | | |
| Pile Height | 1.5 in. | 1.5 in. | 1.5 in. | 1.5 in. | 2.0 in. | 2.5 in. |
| Sand | 3 lbs/sq ft | 3 lbs/sq ft | 3 lbs/sq ft | 3 lbs/sq ft | 1.3 lbs/sq ft. | 4.6 lbs/sq ft |
| Resilient Type | SBR | TPE | SBR | TPE | SBR | SBR |
| Resilient Amount | 1.1 lb/sq ft | 1.4 lb/sq ft | 1.1 lb/sq ft | 1.4 lb/sq ft | 2.9 lb/sq ft | 4.6 lb/sq ft |

The dimensional properties and differences of the systems are apparent from viewing the last four rows of the table. Thus, it can be seen that systems employing various aspects of the present invention have equivalent safety measurements while offering better performance measurements. It is important to note that the above measurements are exemplary only and are not meant to limit or impose criteria on the claimed invention.

Thus, certain systems employing various aspects of the present invention may have several advantages over traditional systems. Such aspects employ a two-part shock absorption layer (pad and infill) which enables design optimization of safety (g-max) and playability performance (vertical deformation, ball rebound). In other words, the systems are firm, but safe.

Certain embodiments are not dependent on the grading and compaction of an OGBC drainage layer for drainage. This results in less natural soil material removed because the systems have less height and require less soil stabilization and compaction (because the soil will not be exposed to water). It lessens construction time and effort required for base aggregate testing and approval. Furthermore, there are less subsequent base drainage performance concerns.

Such systems are also more environmentally friendly than traditional systems because the drainage pad may be formed of recycled and/or recyclable materials.

The abstract of the disclosure is provided for the sole reason of complying with the rules requiring an abstract, which will allow a searcher to quickly ascertain the subject matter of the technical disclosure of any patent issued from this disclosure. It is submitted with the understanding that it will not be used to interpret or limit the scope or meaning of the claims.

Any advantages and benefits described may not apply to all embodiments of the invention. When the word “means” is recited in a claim element, Applicant intends for the claim element to fall under 35 USC 112, paragraph 6. Often a label of one or more words precedes the word “means”. The word or words preceding the word “means” is a label intended to ease referencing of claims elements and is not intended to convey a structural limitation. Such means-plus-function claims are intended to cover not only the structures described herein for performing the function and their structural equivalents, but also equivalent structures. For example, although a nail and a screw have different structures, they are equivalent structures since they both perform the function of fastening. Claims that do not use the word means are not intended to fall under 35 USC 112, paragraph 6.

The foregoing description of the embodiments of the invention has been presented for the purposes of illustration and description. It is not intended to be exhaustive or to limit the invention to the precise form disclosed. Many combinations, modifications and variations are possible in light of the above teaching. Undescribed embodiments which have interchanged components are still within the scope of the present invention. It is intended that the scope of the invention be limited not by this detailed description, but rather by the claims appended hereto.

For instance, in certain embodiments there is a synthetic turf system comprising: a water barrier or impermeable layer adapted to be placed on top of a soil surface; a water permeable foam pad for the collection and drainage of water; a substrate material having a first side, a second side, and a plurality of weep holes to allow water to pass from the first side to the second side; a plurality of tufts coupled to the substrate material formed to resemble grass; a layer of non-resilient particles placed on the substrate material, and a layer of resilient particles placed on top of the layer of non-resilient particles.

What is claimed is:

1. A synthetic turf system comprising:
a water impermeable liner adapted to be placed above a soil surface;
a water permeable cross-linked polyethylene foam pad having a top side and a bottom side, wherein the bottom side is placed above the water impermeable liner and having a plurality of channels defined on the bottom side for the collection and drainage of water;
a substrate material having a first side, a second side, and a plurality of holes to allow water to pass from the first side to the second side;
a plurality of tufts coupled to the substrate material and extending 1.3″ to 1.8″ from the first side of the substrate material;
a layer of non-resilient particles positioned on the first side of the substrate material, wherein the layer of non-resilient particles has a thickness substantially in the range of 8 to 12 mm; and
a layer of resilient particles placed on top of the layer of non-resilient particles, wherein the layer of resilient particles has a thickness substantially in the range of 8 to 12 mm.

2. The synthetic turf system of claim 1, wherein the non-resilient particles is silica sand.

3. The synthetic turf system of claim 2, wherein the silica sand has an average mesh size between 20 to 40 mesh.

4. The synthetic turf system of claim 1, wherein the resilient particles is selected from the group consisting of rubber and elastomeric materials.

5. The synthetic turf system of claim 1, wherein the water permeable cross-linked polyethylene foam is a high density polyethylene foam.

6. The synthetic turf system of claim 1, wherein the water permeable cross-linked polyethylene foam pad has a thickness range between 0.75″ to 1.25″.

7. The synthetic turf system of claim 1, wherein the plurality of channels have a trapezoidal cross-sectional shape.

8. The synthetic turf system of claim 1, wherein the substrate further comprises:
a top layer of woven polypropylene fabric,
an intermediate layer of non-woven fabric,
a bottom layer of woven polypropylene fabric, and
a layer of polyurethane applied to the bottom layer.

9. The synthetic turf system of claim 1, wherein the water permeable cross-linked polyethylene foam comprises a plurality of foam particulates having diameters ranging from approximately ⅛″ to 1″.

10. The synthetic turf system of claim 1, wherein the water permeable cross-linked polyethylene foam comprises a plurality of randomly dispersed foam particulates.

11. The synthetic turf system of claim 1, wherein the water permeable cross-linked polyethylene foam comprises a plurality of randomly dispersed foam particulates which have been fused together.

12. A synthetic turf kit comprising:
a plurality of rolls of water impermeable material adapted to be placed above a soil surface when unrolled;
a plurality of rolls of water permeable foam pads having a plurality of longitudinal channels defined on one side;
a plurality of rolls of a synthetic turf material, wherein the synthetic turf material comprises:
a multi-layer substrate;
a plurality of perforations defined through the multi-layer substrate; and
a plurality of tufts having an average length extending between 1.3″ to 1.8″ away from the substrate;
a predetermined amount of non-resilient particles having an average mesh size ranging from 10 to 50; and
a predetermined amount of resilient particles for placement on top of the layer of non-resilient particles having a mesh size ranging from 8 to 22.

13. The synthetic turf kit of claim 12, wherein the perforations are weep holes positioned at a predetermined spacing.

14. The synthetic turf kit of claim 12, wherein the resilient particles is selected from the group consisting of rubber or elastomeric materials.

15. The synthetic turf kit of claim 12, wherein the water permeable foam is selected from the group consisting of recyclable foam, cross-linked polyethylene foam, and cross-linked high density polyethylene foam.

16. The synthetic turf kit of claim 12, wherein the water permeable foam pad has a thickness ranging from approximately 0.75″ to 1.25″.

17. The synthetic turf kit of claim 12, wherein the plurality of channels have a trapezoidal cross-sectional shape.

18. The synthetic turf kit of claim 12, wherein the water permeable foam comprises a plurality of randomly dispersed foam particles.

19. The synthetic turf kit of claim 12, wherein the multi-layer substrate further comprises:
a top layer of woven polypropylene fabric,
an intermediate layer of non-woven fabric,
a bottom layer of woven polypropylene fabric, and
a layer of polyurethane applied to the bottom layer.

20. A method of installing a synthetic turf system comprising:
grading a soil surface to a predetermined grade;
placing a water barrier on top of the soil surface;
positioning a water permeable foam pad having a plurality of channels defined on the one side on top of the water barrier such that the plurality of channels face the water barrier;
placing water permeable turf material on top of the water permeable foam;
placing a layer of non-resilient particles on top of the synthetic turf material to a depth of approximately 8 to 12 mm; and
placing a layer of resilient particles on top of the layer of non-resilient particles to a depth of 8 and 12 mm.
